(19) United States
(12) Patent Application Publication
(10) Pub. No.: US 2008/0277460 A1
(43) Pub. Date: Nov. 13, 2008

(54) Container Made of Laminate Material, Blank and Method

(76) Inventors: Arne Nicolay Mohn, Rome (IT); Erik Stabell Sauge, Holmsbu (NO)

Correspondence Address: CALFEE HALTER & GRISWOLD, LLP, 800 SUPERIOR AVENUE, SUITE 1400, CLEVELAND, OH, 44114, US

(21) Appl. No.: 11/629,002

(22) PCT Filed: Jun. 10, 2005
(86) PCT No.: PCT/GB05/02292

§ 371 Date: Jun. 30, 2008

(30) Foreign Application Priority Data
Jun. 10, 2004 (GB) 0412965.6
Mar. 21, 2005 (GB) 0505653.6

(51) Int. Cl. B65D 5/00; B31B 1/25; B31B 1/26; B65D 25/40

(52) U.S. Cl. 229/108; 493/59; 493/162; 222/566

(57) ABSTRACT

A container comprised of laminate material, the material having opposite, downwardly extending, first and second edges (12 and 14), the container comprising one or more of the following features: firstly, the laminate material includes a fibrous cellulosic layer (11), the direction of the majority of fibres (13) in the layer (11) being substantially parallel to the first edge (12); secondly, the container includes a piece constituted by the laminate material and providing a body of the container, the container also including a bottom closure insert under which a bottom strip of the piece is folded and sealed, the insert including a substantially annular flange embraced by the piece, the embracing material consisting of an upper section that contains the flange and a lower section that does not contain the flange and is of at least one fifth of the height of the upper section; and, thirdly, the container having a flat top, and including a reinforcement over a corner of the flat top.

This invention relates to a container blank, a container, a package, and a system and method for forming the container.

It is known to form a carton blank by printing, scoring and cuffing it from a continuous web of laminate material. At this stage the blank is formed into a flat, longitudinally seamed, carton sleeve. The carton sleeve is then typically transported to a form, fill and seal machine where the sleeve is made into the finished carton.

U.S. Pat. No. 5,622,308 discloses a frusto-conical, paper container for fluid substances. The container comprises a tapered trunk formed by rolling a sheet comprising a barrier layer applied onto a surface of cardboard, and by joining lengthwise edge zones of the sheet with each other; and a bottom member formed from a disk-shaped sheet comprising a barrier layer applied onto a surface of cardboard, a lower end portion of the trunk and a peripheral portion of the bottom member being engaged and joined with each other in such a manner that the respective barrier layers face each other. One of the edge zones for forming the lengthwise joint of the trunk has an extending film which surrounds a longitudinal edge surface of the cardboard and reaches an external surface of the cardboard. The second edge zone of the joint has a stepped portion which bends outside from an end-surface position of the first edge zone and extends along an external surface of the first edge zone. An inner film of the second edge zone is directly or indirectly joined with the extending film of the first edge zone.

Patent Abstracts of Japan Publication JP-A-2000-103421 discloses a cup-form or cylindrical container having a side wall and a bottom. A double-face corrugated fibreboard sheet which forms the side wall is stuck in such a manner that a front layer (container external surface) material and/or a rear layer (container internal surface) material are stuck to a central core material with a thermoplastic resin layer. The whole body is cut out into a square shape or a fan shape, and a cross-sectional portion of the double-face, corrugated fibreboard sheet, which is exposed at the inside of a joint, is skived, the front layer material and the central core material being removed. The rear layer material is folded back, and heat-bonded with the rear layer surface using the thermoplastic resin coating on the internal surface of the container, and the cross-section is covered.

U.S. Pat. No. 2,661,138 discloses a container including a tubular body formed of a sheet-like blank having underlapping and overlapping ends to form a so-called centre seam of increasing width from the bottom toward the top of the body to provide a relatively wide lap across the top of the body and a relatively narrow lap at the bottom of the body, the underlapped end having a pour opening within the relatively wide upper portion of the side seam and spaced inwardly from edges of the ends, the overlapped end having an edge face forming substantially a right-angle with the surface of the underlapped end and having transverse lines of perforations extending from the edge face inwardly of the overlap at the upper and lower sides of the pour opening to termination points inset from a corresponding edge of the underlap to provide a transverse tear flap in the overlap in covering relation with the pour opening. The container has a gable top provided with the tear strip and has a circular base closed by a disc-like insert which has a depending annular flange that engages the inner face of the base of the body above an arcuate strip of adhesive which is applied along the lower arcuate edge of the sheet-like blank and which seals therewith when that arcuate edge is turned refractively along the inner face of the flange to form the base edge of the container. The container has those top closure obturating sub-panels defining its gable ends bounded by respective score lines extending along the fan-shaped blank, with other score lines extending from the upper edge of the blank to those score lines, and with triangular, further score lines sub-dividing those top closure obturating sub-panels.

According to a first aspect of the present invention, there is provided a container comprised of a lap-jointed loop of laminate material, said loop having opposite, downwardly extending, first and second edges, said container comprising one or more of the following features:
said laminate material including a fibrous cellulosic layer, the direction of the majority of fibres in the fibrous cellulosic layer being substantially parallel to the first edge;
said loop providing a body of said container, said container also including a bottom closure insert under which a bottom strip of said loop is folded and sealed, said insert including a substantially annular flange embraced by said loop, the embracing material consisting of an upper section that contains the flange and a lower section that does not contain the flange and is of at least one fifth of the height of the upper section; and
said container having a flat top, and including a reinforcement over a corner of said flat top.

Owing to this aspect of the invention, it is possible to provide a container that is well suited to being stacked upon an identical container. The stackability of the containers is improved by one or more of the three features, with the upright fibres in the container providing increased strength, the formation of the bottom portion of the container increasing rigidity, and the reinforcement on the top portion improving the ability of the container to support the weight of a container placed on top.

According to a second aspect of the present invention, there is provided a container blank of laminate material, with opposite, substantially rectilinear, first and second edges converging towards each other, the blank including first, second, third, fourth and fifth closure panels in a row, and the fifth closure panel being narrower than each of the first, second, third and fourth closure panels and being bounded by the first edge, the blank having a line of weakness separating the fourth and fifth closure panels, the line of weakness and said first edge converging towards each other in the same sense as do said first and second edges, wherein said line of weakness ends at approximately half-way down the container blank.

According to a third aspect of the present invention, there is provided a method of forming a container blank of laminate material, comprising cutting out the blank from laminate material so that the blank has opposite, substantially rectilinear, first and second edges converging towards each other, and scoring said material so as to form lines of weakness in the blank so that the blank includes a row of first, second, third, fourth and fifth closure panels, the fifth closure panel being narrower than each of the first, second, third and fourth closure panels, the first edge and the line of weakness separating the fourth and fifth closure panels converging towards each other in the same direction as do said first and second edges, wherein said line of weakness is formed to end approximately half-way down the container blank.

According to a fourth aspect of the present invention, there is provided a container comprised of a piece of laminate material, said piece having opposite, downwardly extending, first and second edges, said container including a downwardly extending seam bounded by said first and second edges respectively internally and externally of the container, said container including a loop comprised of first, second, third, fourth and fifth closure panels, the fifth closure panel being narrower than each of the first, second, third and fourth closure panels, and said container having a fold separating the fourth and fifth closure panels, with said fold and said first edge converging downwardly towards each other, wherein said fold ends approximately half-way down the container.

Owing to these aspects of the invention, it is possible to seam the blank more appropriately along a tapering mandrel. Moreover, with the fifth closure panel used for a so-called “side seam”, i.e. a seal at a corner of the corresponding end closure of the container, a more aesthetic container is produced than if a so-called “centre seam” were to be used, because the seal at the corner is less likely to be noticed by the consumer, and there should not be any print mismatch at the seal.

According to a fifth aspect of the present invention, there is provided a method comprising producing a container blank of laminate material, said producing comprising skiving a linear zone of laminate material, and cutting out the blank from the laminate material so that the blank has first and second, opposite, substantially rectilinear edges, and the skived zone extends along and bounds the first edge.

Owing to this aspect of the invention, instead of the blank being skived after it has been cut from the laminate material, the skiving takes place on the laminate material so that the skiving can be more easily performed, particularly because the laminate material can be more easily controlled than the cut-out blank.

The laminate material will typically be paperboard with innermost and outermost layers of plastics. The paperboard is to provide strength in the resulting container, and those plastics layers provide moisture barrier and sealing properties. There may be between the paperboard and that innermost layer at least an oxygen barrier layer of aluminium or plastics. If the paperboard comes into contact with the liquid contents of the container, then the paperboard will absorb the liquid. This can occur when the blank is folded round to make the container sleeve, as one edge of the laminate material will be on the inside of the container. Skiving is a process of milling or cutting away some of the thickness of the laminate material at an edge zone and then scoring and folding-over this zone. This ensures that only the outermost layer of the laminate material is exposed at the edge zone, the inner layers being covered by the fold of material.

According to a sixth aspect of the present invention, there is provided a container blank of laminate material, with opposite, substantially rectilinear, first and second edges converging towards each other, the laminate material including a fibrous cellulosic layer, the direction of the majority of fibres in the fibrous cellulosic layer being substantially parallel to the first edge.

According to a seventh aspect of the present invention, there is provided a method comprising producing a container blank of laminate material, said producing comprising cutting out the blank from laminate material including a fibrous cellulosic layer, so that the blank has opposite, substantially rectilinear, first and second edges converging towards each other, and that the direction of the majority of fibres in the fibrous cellulosic layer is substantially parallel to said first edge.

Owing to these aspects of the invention, it is possible to provide a container in which the general direction of the fibres is longitudinal of the container. Since the fibrous cellulosic layer is stronger in the direction of the fibres than in the transverse direction, by having the fibres running along the container, the amount of upright strength in the resulting container is greater. This enables a greater height of containers to be stacked on top of each other, than would be the case if the direction of the fibres were to be around the container. If the geometry of the lower part of the container is rounded, this will reduce the amount of bulging that is possible in the finished container.

According to an eighth aspect of the present invention, there is provided a package including a top portion to be inserted into a recess in a bottom portion of an identical package to be stacked thereon, said package including a container including a bottom insert which comprises a substantially flat floor with a downward, peripheral flange, a side wall of the container encircling the bottom insert and being upwardly folded under said flange, said floor being at a height such that the material embracing the flange consists of an upper section which contains the flange and a lower section which does not contain the flange and is of a height equal to at least one fifth of the height of the upper section, the gap between said floor and the lowest point of the container being greater than the height of said top portion.

According to a ninth aspect of the present invention, there is provided a method of forming a container, comprising causing a bottom portion of the container, which bottom portion comprises a substantially flat floor with a peripheral flange, to be encircled by a side wall of a container sleeve, and folding the side wall of the container sleeve about said flange so that the container sleeve embraces said flange and so that the embracing material includes an upper section which contains the flange and a lower section which does not contain the flange and is of a height at least one fifth of the height of the upper section.

Owing to these aspects of the invention, it is possible to form a container with sufficient space in the underneath, in the form of a cavity, to be able to stack stably thereon an identical container. If the bottom portion is made of laminate material, including paperboard, the cavity can be provided by a separate insert fitted into the container sleeve, and sealed thereto with ultrasound, during the forming process.

The top portion, which may comprise a pour spout fitment, does not contact the container above, when they are stacked, buts fits into the cavity below the floor of the bottom portion. In a container that has a circular cross-section at the base, the bottom portion is circular with the flange being preferably annular.

According to a tenth aspect of the present invention, there is provided a container including a piece of laminate material, the piece having opposite, substantially rectilinear, first and second edges, said container reducing in cross-section internally and externally progressing downwardly and including a downwardly extending seam bounded by said first and second edges respectively internally and externally of the container, said container further including a bottom insert which comprises a floor with a downward, peripheral flange, the piece being folded under said flange, and the bottom insert consisting of plastics.

According to a eleventh aspect of the present invention, there is provided a method of forming a container comprising receiving a blank of laminate material with opposite, substantially rectilinear, first and second edges converging towards each other for providing a container sleeve,. applying a bottom insert which comprises a substantially flat floor with a flange, and folding the container sleeve about said flange, the bottom insert consisting of plastics.

Owing to these aspects of the invention, it is possible to form a container having a side wall of laminate material, with a bottom insert that is not of laminate material. This allows greater flexibility in the manufacture of the bottom portion, since the insert does not need to be cut from a web or sheet of laminate material, so reducing waste of laminate material which can be difficult to recycle. The bottom insert can either be made individually or be cut from a web or sheet of plastics, with the waste plastics being recycled.

According to a twelfth aspect of the present invention, there is provided a system for producing packages, comprising first apparatus for cutting flat blanks from a web of laminate material, each blank having opposite, substantially rectilinear, first and second edges converging towards each other, and a second apparatus for receiving each flat blank, forming each blank into a container sleeve of which the perimeter changes along the sleeve, longitudinally sealing the sleeve, sealingly closing the bottom of each sleeve, and filling and top-sealing each sleeve.

Owing to this aspect of the invention, it is possible to form a container, in a relatively flexible process, that reduces the number of steps required at a conversion stage where the web is converted. There is no requirement to seal any part of the blank at this stage, meaning that a flat blank can be supplied to a form-fill-seal machine constituting the second apparatus. There is also no need to score the blanks at the conversion stage; this again can be done at the form-fill-seal machine.

By providing to the second apparatus flat blanks which are neither sealed nor scored in any way, certain process steps that are normally carried out at the conversion stage can be moved to the forming stage of the second apparatus, with an increase in efficiency. These steps can include printing of the blank; they can also include creating a window in the container (for example so that the user can see the content level in the container), embossing and hot stamping, which is used to apply metal patches and/or holograms to the container for aesthetic reasons. These latter two steps are normally slower to perform than the simple cutting of the blanks, so moving them to the container forming stage (which is normally a slower process) allows the blank cutting to be speeded up, without the container forming being slowed down.

Each apparatus may consist of a plurality of individual machines, which may be located in series at the same location. Advantageously, the second apparatus applies to each blank, while flat and not folded, a pour spout fitment.

According to a thirteenth aspect of the present invention, there is provided a package including a bottom portion, said package including a container including a top part to support a bottom portion of an identical package to be stacked thereon, the first-mentioned package further including a reinforcement extending over a top corner of the first-mentioned container.

According to a fourteenth aspect of the present invention, there is provided a method of forming a package, including applying a reinforcement to a top corner of a container constituting part of said package.

Owing to these aspects of the invention, it is possible to mitigate damage to the top part of the container when another package is stacked on top of it.

According to a fifteenth aspect of the present invention, there is provided a container blank comprising a row of top closure panels, lines of weakness separating said top closure panels from each other, a row of body panels, and further lines of weakness separating said body panels from each other and not aligned with the first-mentioned lines of weakness, said further lines of weakness serving to bound inward bulges in a finished container.

According to a sixteenth aspect of the present invention, there is provided a container comprised of a ring-form body and a top closure integral with each other and both of sheet material, and a bottom closure not integral with said body and said top closure, said container having a regular internal peripheral surface with inward bulges in said regular internal peripheral surface.

The regular internal peripheral surface may be rectangular, particularly square; pyramidal; circular cylindrical; or frusto-conical, for example.

Owing to these aspects of the invention, it is possible to form a container from a blank of laminate material, with inward bulges at the corners of the container. It is also possible to have a bottom closure that is separate from the laminate material.

In order that the invention may be clearly and completely disclosed, reference will now be made, by way of example, to the accompanying drawings, in which:

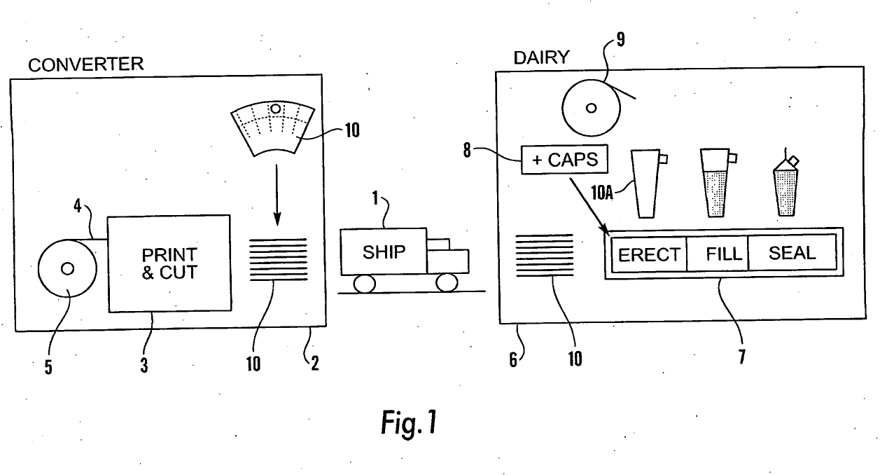

FIG. 1 is a schematic view of a system of forming a container,

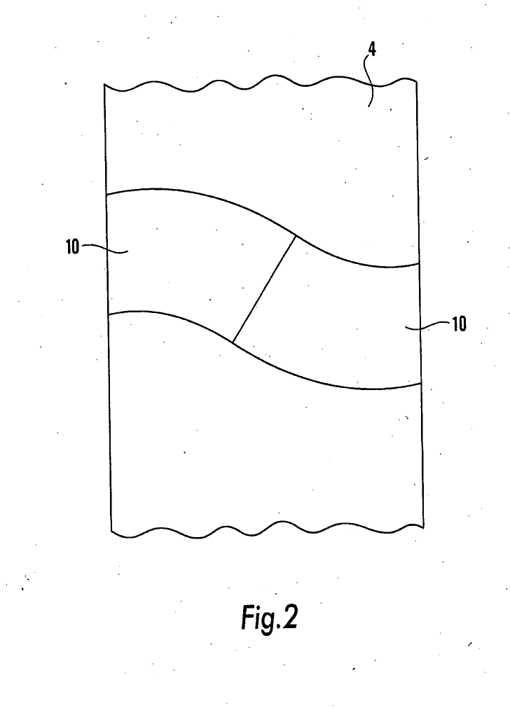

FIG. 2 is a top plan view of a web of laminate material,

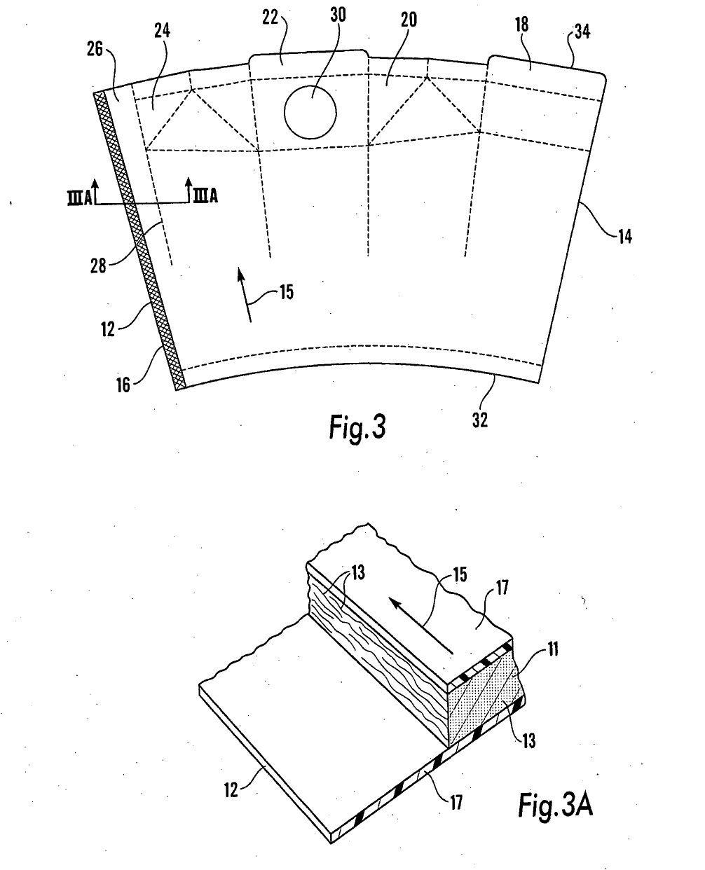

FIG. 3 is a top plan view of a container blank of laminate material, with scorelines illustrated by way of chain lines,

FIG. 3A is a cross-sectional view taken on the line IIIA-IIIA of FIG. 3;

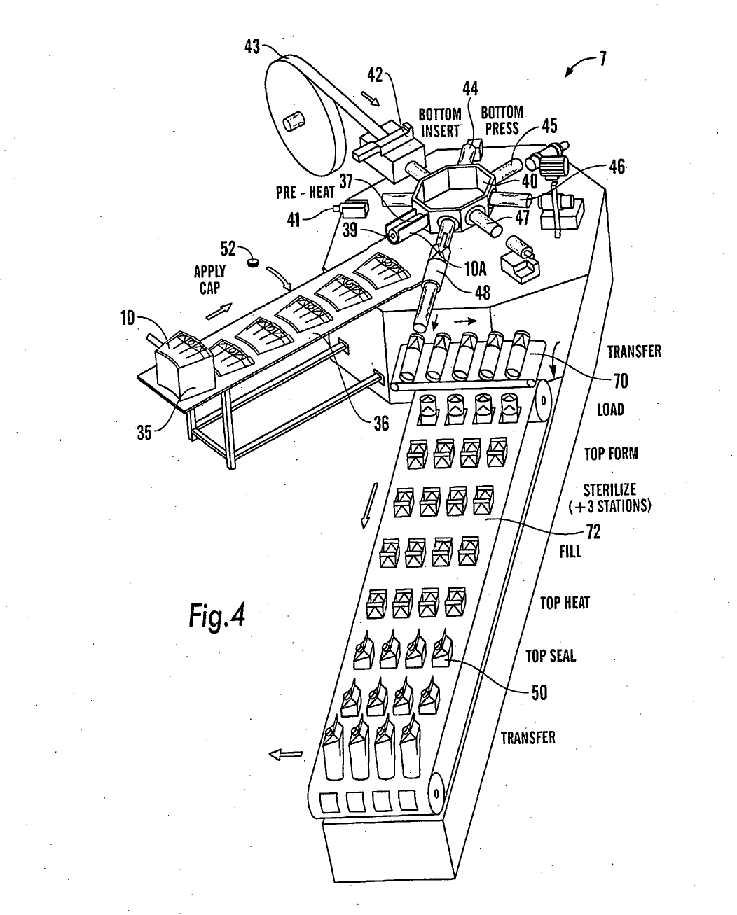

FIG. 4 is a top perspective view of apparatus for forming, filling and sealing each blank,

FIG. 5 is a top perspective view of a container formed from the blank of FIG. 3,

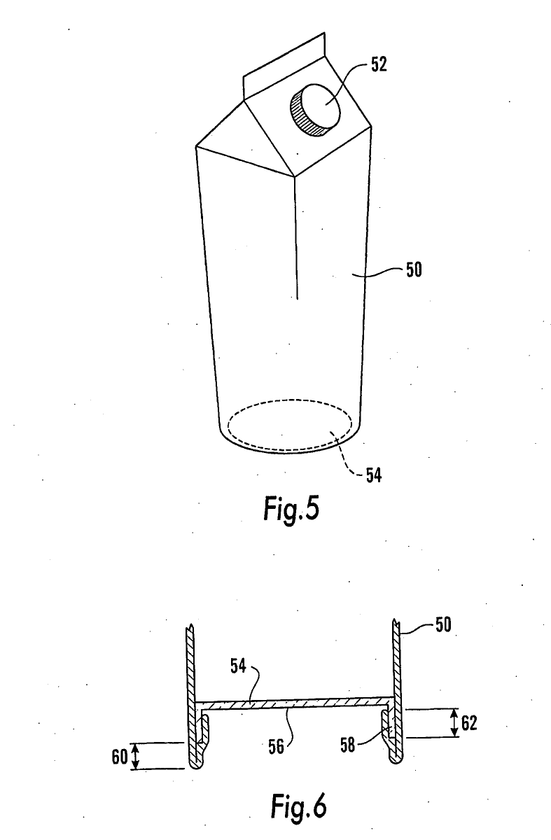

FIG. 6 is a cross sectional view of the lower part of the container of FIG. 5,

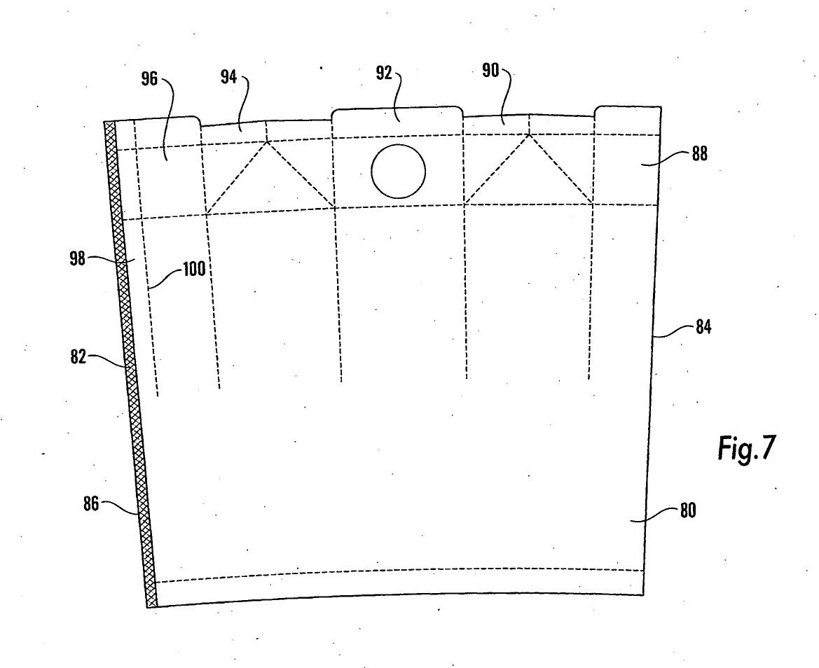

FIG. 7 is a top plan view of a second embodiment of a container blank of laminate material, with scorelines illustrated by way of chain lines,

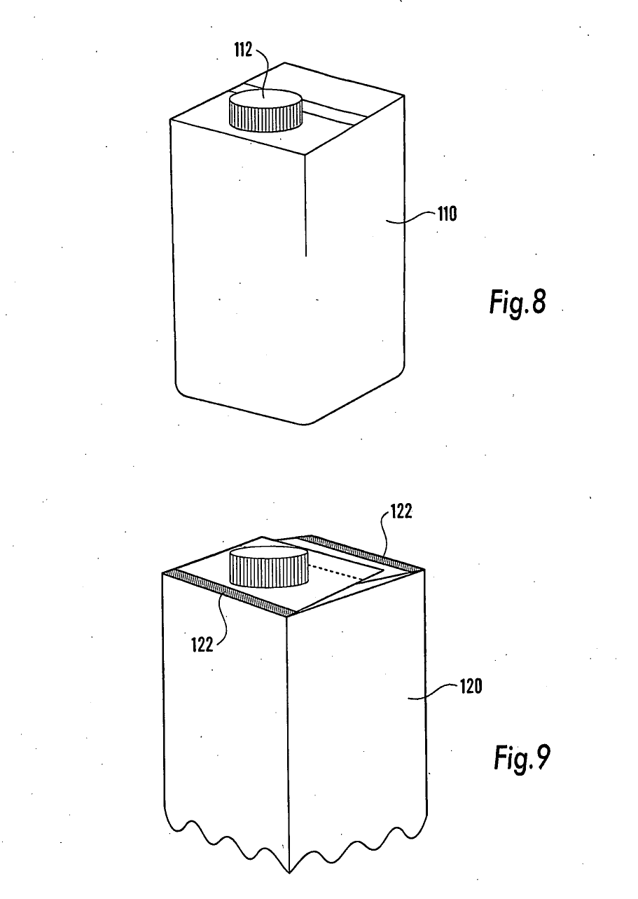

FIG. 8 is a perspective view of a container formed from the blank of FIG. 7,

FIG. 9 is a top perspective view of a third embodiment of the container, and

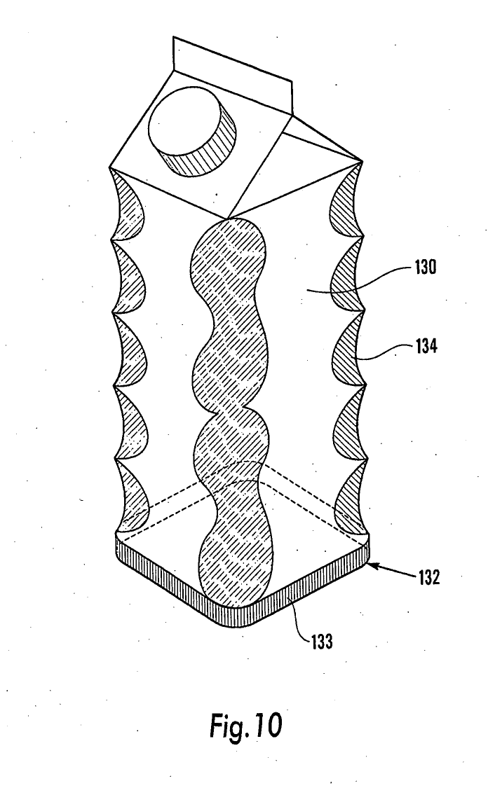

FIG. 10 is a top perspective view of a fourth embodiment of the container.

In a schematic view FIG. 1 illustrates a system for forming a container. At a converting plant 2 there is provided a first apparatus 3 for cutting the blanks 10 from a web 4 of laminate material. The web 4 is supplied from a roll 5, and the web 4 is also printed and skived before it is cut into the individual blanks 10. Each blank 10 has a pair of opposite, substantially rectilinear, converging edges, and the blanks 10 are packaged together for shipping, in this example via a lorry 1 to a dairy 6.

The dairy 6 is provided with a second apparatus 7 (described in more detail below with reference to FIG. 4) for receiving a stack of flat blanks 10, forming each blank 10 into a substantially conical container sleeve 10A, longitudinally sealing the sleeve, closing and sealing the bottom of each sleeve 10A, and filling and top-sealing the sleeve. The second apparatus 7 also receives pour spout fitments 8 (shown in the Figure as “caps”) and a roll of material 9 that is used at a forming stage to provide the bottom portion of each container. The pour spout fitments 8 are applied to the blanks 10 as they pass through the forming apparatus 7. The second apparatus 7 also scores the blanks 10 prior to their forming.

FIG. 2 shows the web of laminate material 4 that is received by the first apparatus 3 in the converting plant 2. The web 4 passes through a skiving station (not shown) that skives the edges of the web 4, to remove a portion of the thickness of the web 4 at each edge of the web and then creases and folds over the reduced thickness portion of the web to edge-seal the intermediate layers of the laminate of the web 4. The web 4 then passes to a cutting station (not shown), which cuts the web into individual blanks. Two blanks 10 are shown in this Figure as they would be cut from the web 4.

FIG. 4 shows in more detail the apparatus 7, which is used in the dairy to form, fill and seal the flat blanks 10. The blanks 10 are supplied to the apparatus 7 from a blank magazine 35. The magazine 35 passes the blanks 10 in turn to a blank in-feed 36, which is an indexing conveyor. While on the in-feed 36 the blanks 10 may be scored to form a blank 10 according to FIG. 3, for example, and each receive a pour spout fitment 52, and are preheated prior to forming. Each blank 10 in turn is then passed from the in-feed 36 to a forming station 37. At the forming station 37, the blank 10 is wrapped around a substantially conical mandrel 39, thereby forming each blank 10 into a substantially conical sleeve 10A which is then corner seamed.

Eight mandrels are provided on a turntable 40, which rotates in a clockwise direction, passing the sleeve 10A on the mandrel 39 through a series of forming stations.

The mandrel 39 takes the sleeve 10A to a second station 41, which is a preheating station for the internal surface of the lower part of the sleeve 10A. The preheating softens the innermost layer of plastics in the lower region of the sleeve 10A. The sleeve 10A next travels to a station 42 at which is a machine which punches a bottom portion (shown in more detail in FIGS. 5 and 6) from a roll of laminate material 43, and inserts it into the bottom of the conical form sleeve 10A. The sleeve 10A, with the bottom portion inside, then passes to a bottom pressing station 44, which folds a small portion of the conical sleeve 10A about a flange of the bottom portion.

The sleeve 10A passes next to a second bottom heating station 45, where the process of bottom sealing the sleeve 10A is continued. The sleeve then passes to a bottom-rolling-and-heating station 46, where the sleeve 10A is rolled and heated under pressure on the mandrel 39. The sleeve 10A passes to a second bottom pressing station 48 where the bottom portion and the sleeve 10A are further pressed to ensure a perfect seal. It will be understood that in an upright container that is to be stacked, the lower part of the container will come under the most stacking force, and a very good seal in this area is essential to produce a container that is to be of suitable standard.

The sleeve 10A is finally moved to an ejection station 48, where an air blower forces the sleeve 10A off the mandrel 39 to a continuous conveyor 70, that is provided with pits to receive individual sleeves 10A.

The sleeves 10A are then supplied, four-at-a-time, to a second indexing conveyor 72, which is provided with square slots to receive the sleeves 10A. The conveyor 72 then indexes the sleeves 10A along through a series of stations, which for clarity purposes are not shown in detail. These stations, in turn, top-form the sleeves, sterilize them (three stations in series carry out the full sterilization), fill the sleeves 10A (which again can be done at more than one station), top re-break the sleeves 10A, heat the top closure portion of each sleeve, and then top-seal the sleeves 10A to provide the finished containers 50. Alternatively, the top sealing station could be an ultrasound sealing station without a pre-heating station. At the final station, the containers 50 are transferred to boxes or roll containers for transferring to supermarkets.

A container blank 10 is shown in more detail in FIGS. 3 and 3A. The blank 10 is of laminate material and is machine-cut from the web 4 and has a pair of opposite, substantially rectilinear, converging edges 12 and 14. The blank 10 includes a zone 16 bounded by the edge 12, the zone 16 being of skived material. The skived zone 16 has been produced while the blank was still part of the web 4, the skiving having taken place as a continuous process on the web 4 before the cutting into individual blanks takes place.

The laminate material includes a layer of paperboard 11, the general direction of the fibres 13 in the paperboard being substantially parallel to the edge 12. In FIGS. 3 and 3A, the arrow 15 indicates the direction of the fibres 13 in this blank 10. The paperboard 11 is a substrate and the material has innermost and outermost layers 17 of LDPE (low density polyethylene).

The blank 10 includes four closure panels 18 to 24, of substantially similar widths, and a fifth, smaller closure panel 26. The blank 10 has a score line 28 separating the fourth panel 24 and the fifth panel 26. This score line 28 converges with the closest edge 12 of the blank 10. The blank 10 is also provided with a plurality of other score lines, for use when the blank 10 is eventually formed into a container. The blank 10 is also provided with a hole 30 for receiving the pour spout fitment.

The blank has two substantially arcuate edges 32 and 34, defining respectively the eventual bottom and top of the resulting sleeve 10A. The arc length of the top edge 34 (which is made up of a series of straight edges) is greater than the arc length of the bottom edge 32 (which is likewise made up of a number of straight and semi-arched edges). The top closure, which is made up of the panels 18 to 24, is designed to be ultimately folded and sealed into a gable top finish. In the design of the blank 10 shown in this Figure, the gable top will be asymmetrical, with the panel 22 being larger than the panel 18, to accommodate a larger pour spout fitment.

FIG. 5 shows an example of the finished container 50 that is made using the blank 10 illustrated in FIG. 3. The container 50 has a pour spout fitment 52 on a top closure, and also includes a bottom portion 54. The bottom portion 54 is a separate insert that is provided after the sleeve 10A has been formed and, like the pour spout fitment 52, is fixed to the blank 10 during the forming process. The container 50 is typically used for liquid food such as milk or orange juice, but is in fact suitable for storing any liquid that is required to be provided to consumers, such as detergents or the like. The container 50 provides the user with a good grip when it is handled, and is unlikely to bulge owing to the increased strength of the container, and its rounded shape. Since the container is less likely to bulge, less paperboard is needed in the laminate material, with a 30% saving in material. The container still gives the traditional advantages of the conventional container, such as providing a good seal and being able to support the pour spout fitment 52, which is of a screw cap character.

FIG. 6 illustrates the lower part of the container in more detail. The bottom portion 54 comprises a substantially flat floor 56 with a downward, peripheral flange 58. The side wall of the container is folded under the flange 58, the bottom portion 54 being at a height such that the folded material includes a section 60 that does not contain the flange 58 and is of a height of at least one fifth of the height of the section 62 that does contain the flange, the gap between the floor 56 and the bottom extremity of the container 50 being greater than the projecting height of the pour spout fitment 52.

The flange 58 is approximately 10 mm in height and the section 60 is approximately 5 mm in height, giving a total clearance of about 15 mm from the base of the container 50 to the floor 56. The height of the pour spout fitment 52 is approximately 14 mm and this allows the finished containers to be stacked on top of each other, with the pour spout fitment nesting in the space at the bottom of the container above.

FIG. 7 shows a top plan view of a second embodiment of a container blank 80 of laminate material. As in the first embodiment of the blank, the blank 80 is of laminate material and is machine-cut from a web 4 and has a pair of opposite, substantially rectilinear, converging edges 82 and 84. The blank 80 includes a zone 86 bounded by the edge 82, the zone 86 being of skived material. The skived zone 86 is produced while the blank is still part of the web of material, the skiving taking place as a continuous process on the web of material before the cutting into individual blanks takes place.

The blank 80 includes five closure panels 88 to 96, and a sixth, narrower closure panel 98. The blank 80 has a score line 100 separating the fifth panel 96 and the sixth panel 98. This score line 100 converges with the closest edge 82 of the blank 80. The blank 80 is also provided with a plurality of other score lines, for use when the blank 80 is eventually formed into a container. The blank 80 is also provided with a hole 102 for receiving the pour spout fitment.

FIG. 8 shows a container 110 formed from the blank 80 shown in FIG. 7. The container 110 is one that would typically be used for fresh food products. The container has a flat top rather than a gable top and is provided with a pour spout fitment 112. The base of the container is not circular in cross-section, but is square with rounded corners. The blank 80 from which this container is made is nevertheless substantially similar to the blank shown in FIG. 3. It differs from the blank of FIG. 3 in that, although the pair of opposite, substantially rectilinear edges are converging, they do not converge at the same rate as do the opposite edges in the first embodiment 10 of the blank.

The screw cap 112 protrudes about 14 mm from the top of the container 110, and this will disappear into the cavity of the bottom of the container above when they are stacked one on top of each other.

FIG. 9 shows the top portion of a container 120, which is provided with two strips of thin but hard reinforcing plastics material 122. The plastics material 122 could be of polypropylene, HDPE (high density polyethylene) or a similar plastics. The presence of the plastics material 122 is to protect the top of the container 120 from being damaged by an upper container when the containers are stacked one upon another. The plastics material 122 is arranged so as to distribute the pressure from the bottom edge of the upper container over a larger surface area. The material 122 can be provided on only the four corners of the top surface of the container 120, or can be provided over more of the top surface of the container 120, particularly over the full width of the top to give greater appeal from an aesthetics point of view.

The plastics material 122 can be coloured or transparent, and can be embossed with a design, if so desired. Depending upon the choice of material 122 used, it can be either sealed on using heat sealing or ultrasonic sealing or glued on with spots of glue, either upstream or downstream of the filling of the container 120. In a forming process that applies the material 122, the device that applies the reinforcing plastics material 122 can be switched on or off, depending upon whether the containers produced by the process are to be stacked or not.

FIG. 10 illustrates a container 130, which is formed from a blank of laminated material. The blank has only body sub-panels and top closure sub-panels; there are no bottom closure sub-panels, as the bottom is provided by a bottom closure 132 an upwardly directed, annular, peripheral flange 133 of which is either sealingly received in the lower end of a container sleeve which is to provide the top closure and the body of the container 130 or sealingly receives that lower end. The body sub-panels are separated from each other by upwardly extending edge sections 134, which comprise inward bulges in the body wall of the container 130.

The blank from which the container 130 is made is based upon a standard rectangular format blank and not a conical shape. This saves waste material in relation to a conically shaped design. Owing to the blanks being rectangular, various container heights, and thus capacities, can be catered for with correspondingly various rotary tooling in a plant for conversion of a plastics-coated paperboard web to container blanks, without the width of the blanks needing to be varied. The inward bulges 134 are formed in the container by a series of non-linear scorelines in the blank, which, when the container is erected, form the inward bulges 134. The outer surfaces of the inward bulges 134 can have vertical corner designs applied thereto. The manufacture of the container 130 can be based upon standard milk carton technology and standard paper cup bottom sealing technology.

The bottom closure 132, which may be an injection-moulded plastics unit, is fitted to the bottom of the container sleeve, either over the sleeve, or inside the sleeve with the sleeve then possibly folded under the bottom closure 132 to hold it in place. The closure 132 is of substantially rectangular form, preferably square, with rounded corners. Likewise, the container body has a substantially rectangular, preferably square, cross-section. The top of the container 130 may be of a standard gable top configuration, with a screw cap fitment provided on the top closure.

It is possible to form the longitudinally seamed container sleeve without using a mandrel and then, while controlling the external shape (and thus the internal shape) of at least the lower end zone of the container sleeve, to apply the bottom closure unit 132 thereto and seal the same thereto in a liquid-tight manner, whereafter the partially completed container thus formed can be filled and top-closed and-sealed in a conventional manner. Thus, a form-fill-seal machine employed in the production of a filled and sealed package can be relatively simplified and the risk of introduction of micro-organisms into the container by the use of a mandrel can be avoided. Moreover, the inward bulges can be applied wherever reasonably desired, because there is. no need to cater for withdrawal of a mandrel.

1.-66. (canceled)

67. A container comprised of a lap-jointed loop of laminate material, said loop having opposite, downwardly extending, first and second edges, said loop providing a body of said container, said container including a bottom closure insert under which a bottom strip of said loop is folded and sealed, said insert including a substantially annular flange embraced by said loop, the embracing material consisting of an upper section that contains the flange and a lower section that does not contain the flange and is of at least one fifth of the height of the upper section.

68. A container according to claim 67, said container reducing in its internal and external cross-sections progressing downwardly, said first and second edges being located respectively internally and externally of the container, and the lap joint including a skived and hemmed zone extending therealong at the first edge.

69. A container according to claim 67, wherein said insert consists of plastics.

70. A container according to claim 67, wherein said laminate includes a fibrous cellulosic layer, the direction of the majority of the fibres in the fibrous cellulosic layer being substantially parallel to the first edge.

71. A container according to claim 67, wherein said container has a flat top, and includes a reinforcement over a corner of said flat top.

72. A container according to claim 67, and including first, second, third, fourth and fifth top closure panels in a loop, the fifth top closure panel being located at the lap joint, being narrower than each of the first, second, third and fourth top closure panels and being bounded by said first edge, the container having a fold separating the fourth and fifth top closure panels, wherein the fold and said first edge converge downwardly towards each other.

73. A container according to claim 72, wherein said fold ends at approximately half-way down the container.

74. A container according to claim 67, and further comprising a loop of body panels, folds separating said top closure panels from each other, and further folds separating said body panels from each other and not aligned with the first-mentioned folds, said further folds bounding inward bulges in said container.

75. A container according to claim 71, wherein said reinforcement extends over a pair of adjacent comers of said flat top, and further comprising a second reinforcement extending over another pair of adjacent comers of said flat top.

76. A container according to claim 67, wherein the top of said container is substantially rectangular and the bottom thereof has rounded comers.

77. A method comprising producing a container blank of laminate material, said producing comprising skiving a linear zone of laminate material, and cutting out the blank from the laminate material so that the blank has first and second, opposite, substantially rectilinear edges, and the skived zone extends along and bounds the first edge.

78. A method according to claim 77, and further comprising hemming the skived zone.

79. A method according to claim 77, wherein said laminate material includes a fibrous cellulosic layer, and wherein said cutting out of the blank from the laminate material is such that the direction of the majority of fibres in the fibrous cellulosic layer is substantially parallel to said first edge.

80. A method according to claim 77, wherein said cutting out is such that the first and second edges converge towards each other.

81. A method according to claim 80, wherein said cutting out is such that the blank has opposite, substantially arcuate, third and fourth edges bowed in the direction of the divergence of said first and second edges.

82. A method according to claim 81, wherein said third and fourth edges are substantially concentric with each other.

83. A method according to claim 80, and further comprising scoring said material so as to form lines of weakness in the blank so that the blank includes first, second, third, fourth and fifth top closure panels in a row, with the fifth top closure panel being narrower than each of the first, second, third and fourth top closure panels, being located at said zone and being bounded by said first edge, with said first edge and the line of weakness separating the fourth and fifth top closure panels converging towards each other in the same sense as do said first and second edges.

84. A method according to claim 83, wherein said lines of weakness are formed to end approximately half-way down the container blank.

85. A method according to claim 77, and further comprising scoring said material so as to form a line of weakness in said blank transverse to the first and second edges, so that said blank includes a bottom strip.

86. A method according to claim 77, and further comprising scoring said material so as to form lines of weakness in the blank so that the blank includes a row of top closure panels, and so as to form further lines of weakness so that the blank includes a row of body panels, said further lines of weakness not being aligned with the first-mentioned lines of weakness.

87. A method according to claim 78, and further comprising forming said blank into a container sleeve having a sealed seam along the skived and hemmed zone.

88. A method according to claim 87, wherein said lines of weakness are formed to end approximately half-way down the container blank, and wherein internally and externally said container sleeve is of rectangular cross-section at its top and rounded cross-section at its bottom.

89. A method according to claim 87, and further comprising scoring said material so as to form a line of weakness in said blank transverse to the first and second edges, so that said blank includes a bottom strip, and folding said bottom strip inwardly under a bottom closure insert for said container sleeve.

90. A method according to claim 89, wherein said folding of said bottom strip is inwardly under a substantially annular flange of said insert, whereby said laminate material embraces said flange.

91. A method according to claim 90, wherein said folding is such that the embracing material consists of an upper section that contains the flange and a lower section that does not contain the flange and is of at least one fifth of the height of the upper section.

92. A method according to claim 89, wherein said insert consists of plastics.

93. A method according to claim 87, and further comprising scoring said material so as to form lines of weakness in the blank so that the blank includes a row of top closure panels, and so as to form further lines of weakness so that the blank includes a row of body panels, said further lines of weakness not being aligned with the first-mentioned lines of weakness, wherein said further lines of weakness bound inward bulges in said container sleeve.

94. A method according to claim 87, wherein said forming of said blank into said container sleeve includes wrapping said blank around an axially tapering mandrel.

95. A method according to claim 87, wherein said blank is formed in a converting plant, is shipped in a stack of identical blanks to a packaging plant, and is formed into a container sleeve in said packaging plant.

96. A method according to claim 87, and further comprising scoring said material so as to form lines of weakness in the blank so that the blank includes first, second, third, fourth and fifth top closure panels in a row, with the fifth top closure panel being narrower than each of the first, second, third and fourth top closure panels, being located at said zone and being bounded by said first edge, with said first edge and the line of weakness separating the fourth and fifth top closure panels converging towards each other in the same sense as do said first and second edges, folding inwards and sealing to each other said top closure panels to form a flat-top closure, and affixing a reinforcement over a corner of said closure.

97. A method according to claim 87 and further comprising scoring said material so as to form lines of weakness in the blank so that the blank includes a row of top closure panels, and so as to form further lines of weakness so that the blank includes a row of body panels, said further lines of weakness not being aligned with the first-mentioned lines of weakness, folding inwards and sealing to each other said top closure panels to form a flat-top closure, and affixing a reinforcement over a corner of said closure.

98. A container blank of laminate material, with opposite, substantially rectilinear, first and second edges converging towards each other, the blank including first, second, third, fourth and fifth closure panels in a row, and the fifth closure panel being narrower than each of the first, second, third and fourth closure panels and being bounded by the first edge, the blank having a line of weakness separating the fourth and fifth closure panels, the line of weakness and said first edge converging towards each other in the same sense as do said first and second edges, wherein said line of weakness ends at approximately half-way down the container blank.

99. A method of forming a container blank of laminate material, comprising cutting out the blank from laminate material so that the blank has opposite, substantially rectilinear, first and second edges converging towards each other, and scoring said material so as to form lines of weakness in the blank so that the blank includes a row of first, second, third, fourth and fifth closure panels, the fifth closure panel being narrower than each of the first, second, third and fourth closure panels, the first edge and the line of weakness separating the fourth and fifth closure panels converging towards each other in the same direction as do said first and second edges, wherein said line of weakness is formed to end approximately half-way down the container blank.

100. A container comprised of a piece of laminate material, said piece having opposite, downwardly extending, first and second edges, said container including a downwardly extending seam bounded by said first and second edges respectively internally and externally of the container, said container including a loop comprised of first, second, third, fourth and fifth closure panels, the fifth closure panel being narrower than each of the first, second, third and fourth closure panels, and said container having a fold separating the fourth and fifth closure panels, with said fold and said first edge converging downwardly towards each other, wherein said fold ends approximately half-way down the container.

101. A package including a top portion to be inserted into a recess in a bottom portion of an identical package to be stacked thereon, said package including a container including a bottom insert which comprises a substantially flat floor with a downward, peripheral flange, a side wall of the container encircling the bottom insert and being upwardly folded under said flange, said floor being at a height such that the material embracing the flange consists of an upper section which contains the flange and a lower section which does not contain the flange and is of a height equal to at least one fifth of the height of the upper section, the gap between said floor and the lowest point of the container being greater than the height of said top portion.

102. A package according to claim 101, wherein said container is formed from a piece of laminate material and said bottom insert, said bottom insert consisting of plastics.

103. A package according to claim 101, and including a top part to support said bottom portion of said identical package, said top part including a reinforcing plastics portion which extends over a top corner of said container and is to have said bottom portion of said identical package placed thereon.

104. A package according to claim 101, wherein said top portion comprises a pour spout fitment.

105. A package according to claim 101, wherein said bottom portion is substantially circular.

106. A package according to claim 101, wherein said bottom portion is substantially square, with rounded corners.

107. A package according to claim 101, wherein said flange is substantially annular.

108. A method of forming a container, comprising causing a bottom portion of the container, which bottom portion comprises a substantially flat floor with a peripheral flange, to be encircled by a side wall of a container sleeve, and folding the side wall of the container sleeve about said flange so that the container sleeve embraces said flange and so that the embracing material includes an upper section which contains the flange and a lower section which does not contain the flange and is of a height at least one fifth of the height of the upper section.

109. A method according to claim 108, wherein said bottom portion consists of plastics.

110. A method according to claim 108, and further comprising affixing to the container a reinforcing plastics portion so that it extends over a top corner of said container.

111. A container including a piece of laminate material, the piece having opposite, substantially rectilinear, first and second edges, said container reducing in cross-section internally and externally progressing downwardly and including a downwardly extending seam bounded by said first and second edges respectively internally and externally of the container, said container further including a bottom insert which comprises a floor with a downward, peripheral flange, the piece being folded under said flange, and the bottom insert consisting of plastics.

112. A method of forming a container comprising receiving a blank of laminate material with opposite, substantially rectilinear, first and second edges converging towards each other for providing a container sleeve, applying a bottom insert which comprises a substantially flat floor with a flange, and folding the container sleeve about said flange, the bottom insert consisting of plastics.

113. A system for producing packages, comprising first apparatus for cutting flat blanks from a web of laminate material, each blank having opposite, substantially rectilinear, first and second edges converging towards each other, and a second apparatus for receiving each flat blank, forming each blank into a container sleeve of which the perimeter changes along the sleeve, longitudinally sealing the sleeve, sealingly closing the bottom of each sleeve, and filling and top-sealing each sleeve.

114. A system according to claim 113, wherein said sealingly closing includes folding said container sleeve about the flange of a bottom insert which comprises a floor with a flange.

115. A system according to claim 113, wherein said first apparatus is arranged to cut said blanks such that each blank has opposite, substantially arcuate, third and fourth edges substantially concentric with each other.

116. A system according to claim 113, wherein said second apparatus is arranged to apply a pour spout fitment.

117. A system according to claim 113, wherein said second apparatus is arranged to apply a reinforcement over a top corner of each container.

118. A container blank comprising a row of top closure panels, lines of weakness separating said top closure panels from each other, a row of body panels, and further lines of weakness separating said body panels from each other and not aligned with the first-mentioned lines of weakness, said further lines of weakness serving to bound inward bulges in a finished container.

119. A container blank according to claim 118 and not having bottom closure panels.

120. A container comprised of a ring-form body and a top closure integral with each other and both of sheet material, and a bottom closure not integral with said body and said top closure, said container having a regular internal peripheral surface with inward bulges in said regular internal peripheral surface.

121. A container according to claim 120, wherein said bottom closure is substantially circular.
